(19) United States
(12) Patent Application Publication
(10) Pub. No.: US 2025/0289754 A1
(43) Pub. Date: Sep. 18, 2025

(54) SYSTEM AND METHOD FOR PRODUCING CEMENT WITH LOW CARBON DIOXIDE EMISSION

(71) Applicant: Arelac, Inc., San Jose, CA (US)

(72) Inventor: Keith Andrew Krugh, Los Gatos, CA (US)

(21) Appl. No.: 19/077,707

(22) Filed: Mar. 12, 2025

Related U.S. Application Data
(60) Provisional application No. 63/564,401, filed on Mar. 12, 2024.

(51) Int. Cl. C04B 7/36; C04B 7/44; C04B 111/00

(52) U.S. Cl. CPC C04B 7/367; C04B 7/4415; C04B 2111/00017

(57) ABSTRACT

System and method of low carbon emission production of cement include a conventional kiln, a precipitation reactor in material communications with the conventional kiln, an indirect heated kiln in material communications with the precipitation reactor, and a sequestration module in material communications with the indirect heated kiln and configured to sequester high purity carbon dioxide produced by the indirect heated kiln. The system may further comprise a compressor, in material communications with the indirect heated kiln and the sequestration module and the precipitation reactor, and configured to produce materialized carbon dioxide.

### CROSS-REFERENCE TO RELATED APPLICATION

This application claims the benefit of priority to U.S. Provisional Patent Application Ser. No. 63/564,401 entitled “SYSTEM AND METHOD FOR PRODUCING CEMENT WITH LOW CARBON DIOXIDE EMISSION,” filed Mar. 12, 2024, the disclosure of which is incorporated herein in its entirety by reference.

### BACKGROUND

As the largest manufactured product in the world, cement production plays a substantial role in anthropogenic CO₂ emissions, contributing to approximately 7-8% of these emissions, as well as consuming over 3% of the global energy demand and emitting over 5% of global anthropogenic PM₁₀ emissions.

Given the ongoing global trends of population growth and urbanization, these environmental impacts are expected to persist unless mitigation strategies are implemented. In recent years, various technical measures have emerged to mitigate these impacts. For instance, the waste CO₂ from cement kilns and fossil fuel incinerators may be harnessed through processes such as carbonation curing, secondary chemical reactions for carbon capture, or geological storage. However, these measures frequently encounter technical and economic challenges when applied in cement plants.

It is therefore desirable to find alternatives ways to produce low or zero carbon emission cement.

### SUMMARY

Some aspects relate to a cement production system including: an Indirect heated kiln configured to produce a first calcined lime and a first exhaust stream including a first CO₂ component; a direct heated kiln configured to produce a second calcined lime and a second exhaust stream including a second CO₂ component; and, a precipitation reactor configured to utilize the second CO₂ component to produce precipitated calcium carbonate from the first calcined lime.

Some aspects relate to a cement production system, further including a sequestration module configured to sequester the first exhaust stream including CO₂.

Some aspects relate to a cement production system, wherein the sequestration module is configured to geologically sequester the first exhaust stream including CO₂.

Some aspects relate to a cement production system, wherein at least one of the direct heated kiln and the indirect heated kiln operates at least partially on a fossil fuel alternative heating mechanism.

Some aspects relate to a cement production system, wherein the fossil fuel alternative heating mechanism includes at least one of electric heating, solar heating, and geothermal heating.

Some aspects relate to a cement production system, wherein the first exhaust stream includes at least 80% pure CO₂.

Some aspects relate to a cement production system, wherein the first exhaust stream includes at least 90% pure CO₂.

Some aspects relate to a cement production system, wherein the second exhaust stream includes CO₂ that is less than 50% pure.

Some aspects relate to a cement production system, wherein the second exhaust stream includes CO₂ that is less than 30% pure.

Some aspects relate to a cement production system, wherein the precipitated calcium carbonate includes at least one of vaterite, aragonite, and calcite.

Some aspects relate to a method for cement production, the method including: Indirectly heating limestone to produce a first calcined lime and a first exhaust stream including a first CO₂ component; directly heating limestone to produce a second calcined lime and a second exhaust stream including a second CO₂ component; and, utilizing the second CO₂ component to produce precipitated calcium carbonated from the first calcined lime.

Some aspects relate to a method, further sequestering the first exhaust stream including CO₂.

Some aspects relate to a method, wherein the sequestering includes geologic sequestration.

Some aspects relate to a method, further using a fossil fuel alternative heating mechanism for at least one of direct heating and indirect heating.

Some aspects relate to a method, wherein the fossil fuel alternative heating mechanism includes at least one of electric heating, solar heating, and geothermal heating.

Some aspects relate to a method, wherein the first exhaust stream includes at least 80% pure CO₂.

Some aspects relate to a method, wherein the first exhaust stream includes at least 90% pure CO₂.

Some aspects relate to a method, wherein the second exhaust stream includes CO₂ that is less than 50% pure.

Some aspects relate to a method, wherein the second exhaust stream includes CO₂ that is less than 30% pure.

Some aspects relate to a method, wherein the precipitated calcium carbonate includes at least one of vaterite, aragonite, and calcite.

Some aspects relate to a system for production of low carbon emission cement, the system including: a conventional kiln; a precipitation reactor in material communications with the conventional kiln; an indirect heated kiln in material communications with the precipitation reactor; and, a sequestration module in materials communications with the indirect heated kiln;

Some aspects relate to a system, further including a compressor in material communications with the indirect heated kiln and the sequestration module.

Some aspects relate to a system, further including a production module in material communications with the precipitation reactor, and configured to produce materialized carbon dioxide.

Some aspects relate to a system for production of low carbon emission cement, the system including: an indirect heated kiln having a first volume and a second volume, the indirect kiln configured to input limestone into the first volume and input heat into the second volume and to produce lime and a first stream of carbon dioxide in the first volume and a second stream of carbon dioxide in the second volume; a precipitation reactor configured to input the lime and the second steam of carbon dioxide and produce precipitated calcium carbonate cement; and a sequestration module configured to input the first stream of carbon dioxide for sequestration.

Some aspects relate to a system, wherein the first stream of carbon dioxide is at least 80% pure.

Some aspects relate to a system, wherein the precipitation reactor inputs a portion of the first carbon dioxide.

Some aspects relate to a system, wherein the indirect heated kiln is configured to input a portion of a third carbon dioxide stream from a conventional kiln.

Some aspects relate to a system, wherein the indirect heated kiln is configured to operate as a pre-calciner.

Some aspects relate to a system, wherein the sequestration module is configured to prepare the first stream of carbon dioxide for geological sequestration.

### BRIEF DESCRIPTION OF THE DRAWINGS

In the accompanying drawings:

FIG. 1 is a schematic illustration of a low-emission cement system according to various aspects.

FIG. 2A is an illustration of the operation of indirect heated kiln 230 in accordance with various aspects.

FIG. 2B is an illustration of various aspects using indirect heated kilns and a precipitation reactor.

FIG. 3 is an illustration of an indirect heated kiln integrated with a CO₂ precipitation processing according to some aspects.

FIG. 4A is an illustration of the sequestration and precipitation processes according to various aspects.

FIG. 4B is an illustration of the system that uses high purity CO₂ for both sequestration and precipitation according to various aspects.

FIG. 4C is an illustration of the system that uses different sources CO₂ and calcined lime for precipitation.

FIG. 5 is an illustration of a flowchart of an example method for cement production according to various aspects.

### DETAILED DESCRIPTION

It is to be understood that this invention is not limited to particular aspects described, as such may, of course, vary. It is also to be understood that the terminology used herein is for the purpose of describing particular aspects only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the invention, representative illustrative methods and materials are described herein.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the invention described herein is not entitled to antedate such publication by virtue of prior invention. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual aspects described and illustrated herein has discrete components and features which may be readily separated from or combined with the features of any of the other several aspects without departing from the scope or spirit of the invention. Any recited method can be carried out in the order of events recited or in any other order, which is logically possible.

Cement production is responsible for 7-8% of all anthropogenic CO₂ emissions, over 3% of global energy demand, and over 5% of global anthropogenic PM₁₀ emissions. With the megatrends of increasing global population and urbanization, these environmental impacts will not decrease if mitigation applications are not adopted. In recent years, various technical measures were found to alleviate these impacts. For example, the CO₂ in the waste gas from a cement kiln and fossil fuels incinerator can be collected for carbonation curing, secondary chemical reactions for carbon capture, geological storage, etc. But these measures often have technical and economic challenges for application in cement plants.

Vaterite, aragonite, and calcite cements may be produced by using re-absorption and precipitation of CO₂ from a cement kiln or from other industrial sources. These different polymorphs are cementitious on their own when mixed with water, and they can also be used as a supplementary material for blended cements. Vaterite is the least stable and more soluble polymorph and rarely exists in nature, whereas aragonite and calcite are the more stable and common crystalline polymorphs. Calcite, in particular, is the most stable of the three polymorphs.

In various aspects, a cement production system including an Indirect heated kiln is configured to produce a first calcined lime and a first exhaust stream comprising a first CO₂ component. This first CO₂ component is considered to have a high purity suitable for sequestration, and in particular, geological sequestration.

In various aspects, a second part of the system is a direct heated kiln configured to produce a second calcined lime and a second exhaust stream comprising a second CO₂ component. This second CO₂ component is considered to have a lower purity, and therefore is not suitable for sequestration, and in particular, geological sequestration.

A geological sequestration scheme, in particular, may require the CO₂ component of the exhaust gas to be up to or more than 90% by weight of the exhaust gas.

Some carbon pools, such as saline aquifers or depleted oil and gas fields, can accept CO₂ with lower purity, as long as the impurities do not affect the storage capacity, injectivity, or security of the reservoir. Other carbon pools, such as enhanced oil recovery (EOR) projects or industrial uses of CO₂, may require higher purity, as the impurities can reduce the efficiency, quality, or safety of the process.

In various aspects, an exemplary system also includes a precipitation reactor configured to utilize the second CO₂ component to produce precipitated calcium carbonate from the first calcined lime. The precipitated calcium carbonate may be in the form of vaterite, aragonite, or calcite.

In various aspects, the cement production system may further include a CO₂ sequestration module configured to sequester, and in particular, geologically sequester, first exhaust stream containing the first CO₂ component.

In various aspects, a cement production system may include a direct heated and a conventional kiln which may operate at least partially on a fossil fuel alternative heating mechanism.

Accordingly, in various aspects, having a green source of heating, such as a fossil fuel alternative heating system, will further reduce the CO₂ emission of the system whereby the total emission may be negligible given that the pure CO₂ component is sequestered, and in particular, geologically sequestered.

In various aspects, in the cement production system, the fossil fuel alternative heating mechanism may be electric heating, solar heating, or geothermal heating, or a combination thereof.

The cement production system may have a first exhaust stream being at least 70% pure, and being more than 90% pure, and therefore suitable for sequestration.

The cement production system may have a second CO₂ component being less than 30% pure, and therefore not suitable for sequestration. However, this component may be used for producing calcium carbonate cement by precipitation. The calcium carbonate cement may be of any polymorph, such as vaterite, aragonite, and calcite, or a combination thereof.

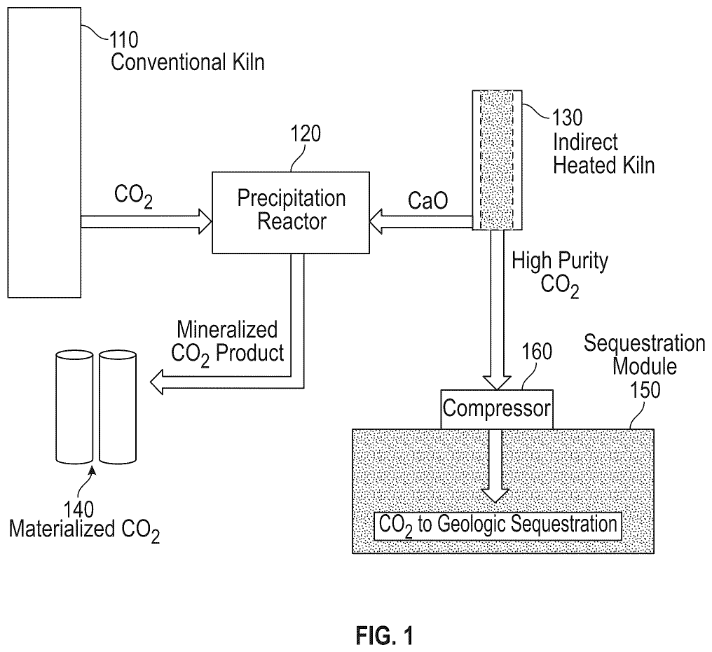

FIG. 1 is a schematic illustration of a low-emission cement system according to various aspects. Such a system may be implemented in a new or existing cement factory according to the aspects disclosed. The system includes conventional kiln 110, indirect heated kiln 130, precipitation reactor 120, compressor 160, sequestration module 150, and materialized CO₂ 140.

In various aspects, a process may start with, e.g., 300 k tons limestone (CaCO₃) milled and fed to the indirectly heated lime kiln. The number 300 k ton is exemplary and any ratio or multiple of the given numbers in these aspects may be used.

The overall CO₂ balance in this scenario, assuming natural gas has been used to heat the indirectly heated lime kiln, may be expressed as: the annual amount of CO₂ produced from heating the lime kiln with natural gas (approximately 0.2 tons CO₂/ton lime) multiplied by the amount of lime produced (168,000 tons of lime) equaling 33,600 tons of CO₂ emissions minus the amount of geologically sequestered CO₂ (132,000 tons) resulting in an overall negative balance of 98,400 tons of CO₂.

The forgoing calculation of the relevant aspects is further illustrated in the table below:

Natural Gas (Lime Kiln Fuel) Case

| | | |
|---|---|---|
| Limestone Feed = Product Produced | 300,000 | MT/yr |
| ×0.44 CO₂:CaCO3 | 0.440 | |
| Mineral CO₂ emitted in lime kiln | 132,000 | MT/yr |
| Limestone (CaCO3) Feed | 300,000 | MT/yr |
| ×0.56 CaO:CaCO3 | 0.560 | |
| CaO produced in lime kiln | 168,000 | MT/yr |
| ×Approx heat demand of kiln | 4.00 | |
| Heat consumption of kiln | 672,000 | GJ/yr |
| ×CO₂ emissions per unit of heat | 0.050 | MT CO₂/GJ |
| | | natural gas |
| Thermal CO₂ emissions from Lime Kiln | 33,600 | MT/yr |
| ÷CaCO3 production | 300,000 | MT/yr |
| CO₂:CaCO3 product | 0.112 | MT CO₂:MT |
| | | Vaterite |
| CO₂:CaCO3 product | 112 | kg CO₂:MT |
| | | Vaterite |
| CO₂ Embodied in Product | 132,000 | MT CO₂/yr |
| CO₂ to Geologic Sequestration | 132,000 | MT CO₂/yr |
| CO₂ Captured from Cement Kiln | 132,000 | MT CO₂/yr |
| (−)CO₂ Captured from Cement Kiln | −132,000 | MT CO₂/yr |
| (+)CO₂ Emitted from Lime Kiln (gas) | 33,600 | MT CO₂/yr |
| CO₂ Emitted (negative = captured) | −98,400 | MT CO₂/yr |
| ÷CaCO3 production | 300,000 | MT/yr |
| CO₂ Emissions per MT of Product | −0.328 | MT CO₂:MT |
| | | Vaterite |
| CO₂ Emissions per MT of Product | −328 | kg CO₂:MT |
| | | Vaterite |

1 MT = metric ton = 1000 kg

If one thus calculates the embodied CO₂ per ton of vaterite cement produced one would get: 98,400 tons CO₂ divided by 300,000 tons of vaterite cement which equals negative 328 kg CO₂ per ton of vaterite cement.

Indirect heating results in generation of 132 k tons of CO₂ from up-heating of the limestone in indirect heated kiln 130. The indirect heating enables the separation of purer first CO₂ stream, produced by the decomposition of the limestone, from a second CO₂ stream that may be generated from the heating process, e.g., burning of fossil fuels. The latter second CO₂ may be much less pure of a stream than the first stream.

In some aspects, the first stream of purer CO₂ may be at least 90%, Or 80%, or 70% pure, whereas the second stream of less pure CO₂ may be less than 30%, or 40%, or 50% pure.

The first CO₂ stream is then compressed by compressor 160 and geologically sequestered in a sequestration site via sequestration module 150.

The resulting 168 k tons of lime (CaO) is then fed to precipitation reactor 120, where it is dissolved and combines with 132 k tons of CO₂ extracted directly from the exhaust stack of conventional kiln 110.

An example of a precipitation reactor is Fortera ReCarb™ Precipitation reactor 120 combines the 168 k tons CaO with the 132 k tons CO₂ to create 300 k tons of precipitated calcium carbonate (CaCO₃) cement. The precipitated calcium carbonate cement may be in one or more polymorphs forms such as vaterite, aragonite, or calcite.

As an illustration of the overall CO₂ emission one may consider an indirect heated kiln, operated with natural gas as its fuel. In such aspects, the overall CO₂ balance in this scenario, assuming natural gas has been used to heat the indirectly heated kiln, may be expressed as: the amount of CO₂ produced from heating the lime kiln with natural gas (approximately 0.2 tons CO₂/ton lime) multiplied by the amount of lime produced (168,000 tons) minus the amount of geologically sequestered CO₂ (132,000 tons) resulting in an overall negative balance of 98,400 tons of CO₂ and divided by 300 k tons of precipitated calcium carbonate cement to produce negative 328 kg of CO₂ per ton of precipitated calcium carbonate cement produced.

In such aspects, calculating the embodied CO₂ per ton of precipitated calcium carbonate cement produced one would get: −98,400 tons CO₂ divided by 300,000 tons of precipitated calcium carbonate cement. This would yield a negative value of −328 kg CO₂ (negative amount) per ton of precipitated calcium carbonate cement.

In various aspects, different types of indirect heated kiln may be used including a shaft kiln, a rotary kiln, and with possible inclusion of a pre-calciner. In various aspects utilizing different types of kilns may be used so long as an exhaust from the decomposition of the limestone may be isolated. This provides a purer stream of CO₂ which is suitable for sequestration in various aspects.

In various aspects, indirect heated kiln 130 may be heated in a variety of ways. In the example shown above, and the resulting calculation, natural gas fuel was used as an example. Indirect heated kiln 130 may use a variety of heating mechanisms.

In various aspects, indirect heated kiln 130 may use a green source of energy for heating. For instance, indirect heated kiln 130 may use electricity, and in particular, green electricity provided by any green electricity source such as solar, wind, hydro, and geothermal source of green electricity. Such aspects provide even a more optimal level of CO₂ emission prevention.

In various aspects, indirect heated kiln 130 may accordingly use green electricity, solar heating, or geothermal heating to further reduce the overall CO₂ emission.

Furthermore, in various aspects, conventional kiln 110 may use various sources of green energy for heating as described above for indirect heated kiln. This will further reduce the overall CO₂ emission.

In various aspects, indirect heated kiln 110 may use different fossil fuel types such as natural gas, coal, various types of liquid fossil fuel such as petroleum products, biofuel, etc.

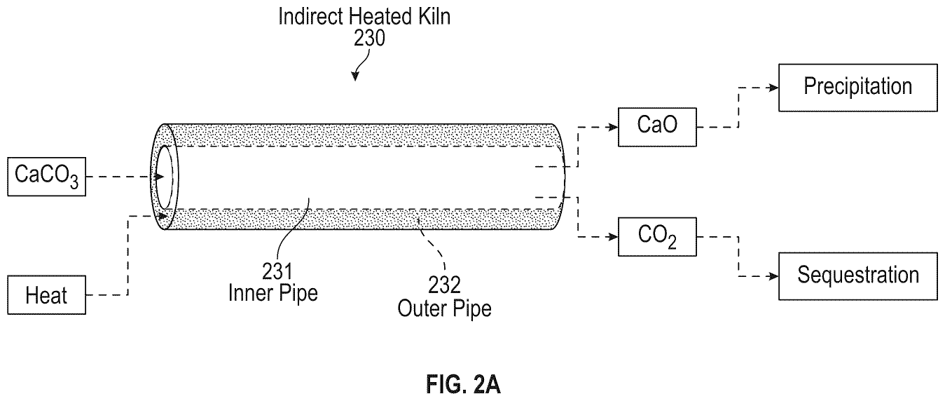

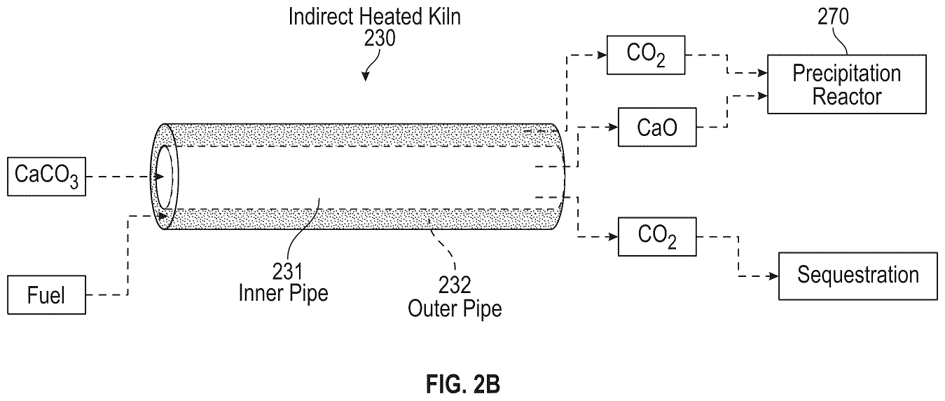

FIG. 2A is an illustration of the operation of indirect heated kiln 230 in accordance with various aspects. Indirect heated kiln 230 includes inner pipe 231 and outer pipe 232. Limestone is fed into the inner pipe, which is isolated from the outer pipe 232. The heating occurs in the outer pipe 232, resulting in the indirect heating of the limestone in the inner pipe 231. The heating, as mentioned above may be generated by utilizing fossil fuel, fossil fuel, alternatives, or green sources of energy as described above.

It should be noted that inner pipe 231 and outer pipe 232 or their equivalent in the ensuing figures, referred to with different reference numerals, are different volumes in an indirect heated kiln. For this reason, the inner and outer pipes may be replaced by any two volumes that are physically separated but energetically in communication. In other words, the two volumes exchange energy, particularly in the form of heat, but are not in material communication, regardless of the phase of the matter being solid, liquid, or gas. As such, any feasible physical shape for these two volumes is acceptable so long as the above stated objectives are met according to various aspects.

The indirect heating process results in the decomposition of the limestone:

CaCO₃→CaO+CO₂

And the resulting production of lime and CO₂ in inner pipe 231 as illustrated in FIG. 2A. The CO₂ produced from the decomposition of the limestone in this fashion is a purer source of CO₂ and therefore suitable for sequestration. The lime (CaO), which is produced in inner pipe 231 is used for precipitation in a precipitation reactor to produce precipitated calcium carbonate cement. The precipitation process needs a source of CO₂ which does not need to be a purer source.

FIG. 2B is an illustration of various aspects using indirect heated kilns and a precipitation reactor. In these aspects a second stream of CO₂, is produced in outer pipe 232, for instance, from the burning of fossil fuel in outer pipe 232. This second stream of CO₂ may not be as pure as the stream generated in inner pipe 231. In various aspect, the second stream of CO₂ may be used along with the lime produced in inner pipe 231, in precipitation reactor 270, to produce precipitated calcium carbonate cement.

In these aspects the purer CO₂ produced in inner pipe 231 may be used for sequestration. In particular, this purer stream of CO₂ may be used for geological sequestration.

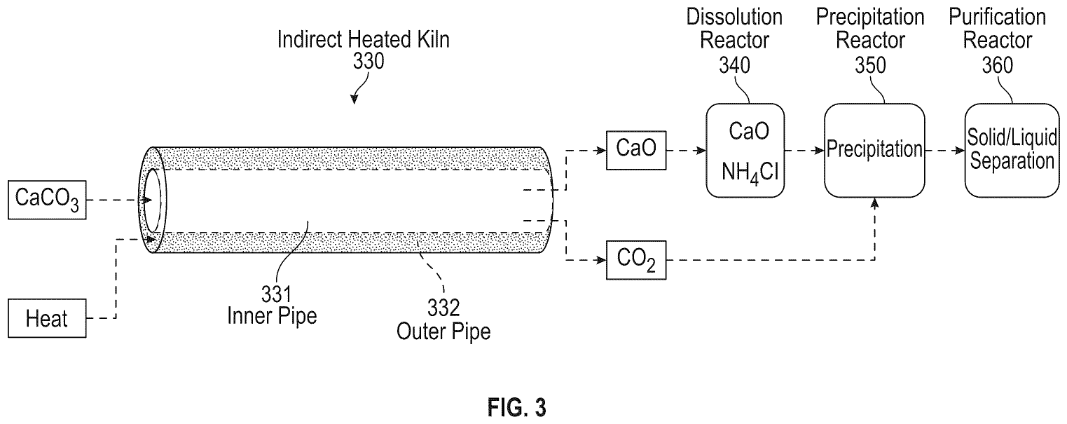

FIG. 3 is an illustration of an indirect heated kiln integrated with a CO₂ precipitation processing according to some aspects. Indirect heated kiln 330 includes inner pipe 331, and outer pipe 332 similar to the previously described aspects.

In various aspects illustrated in FIG. 3, the lime is solvated or dissolved or solubilized with a solubilizer, such as an aqueous base solution, such as an N-containing salt, under one or more dissolution conditions to produce an aqueous solution comprising calcium salt. The N-containing salt solution may for instance be chosen as ammonium chloride NH₄Cl solution and the subsequent calcium salt may be calcium chloride CaCl₂).

The aqueous solution containing calcium salt solids and the dissolved ammonia and/or ammonium salt are contacted under one or more precipitation conditions with the gaseous stream containing CO₂ recycled from the calcination step of the respective process, to form a precipitated calcium carbonate.

FIG. 3 is an illustration of aspects related to recycling a pure stream of CO₂ for precipitation of lime into precipitated calcium carbonate. In these aspects, the purity of the CO₂ is utilized for the precipitation processes leading to the production of precipitated calcium carbonate from lime and the CO₂. Accordingly, there will be no need for a scrubbing process to ensure the purity of the product.

As seen in FIG. 3, indirect heated kiln 330 includes inner pipe 331 which takes in CaCO₃ while the heat is applied indirectly through outer pipe 332. The calcination process produces lime and carbon dioxide as seen in the figure. The lime interacts with an N-containing salt such as NH₄Cl in the dissolution reactor 340 and the product is sent to precipitation reactor 350 along with the pure carbon dioxide from inner pipe 331 where precipitated calcium carbonate is produced. Purification reactor 360 is where solid and liquid products are separated and may be recycled for further use in the process shown in the figure.

In the process of various aspects according to FIG. 3, a scrubbing process is not necessary due to the high purity of the carbon dioxide stream produced in inner pipe 331 of indirect heated kiln 330.

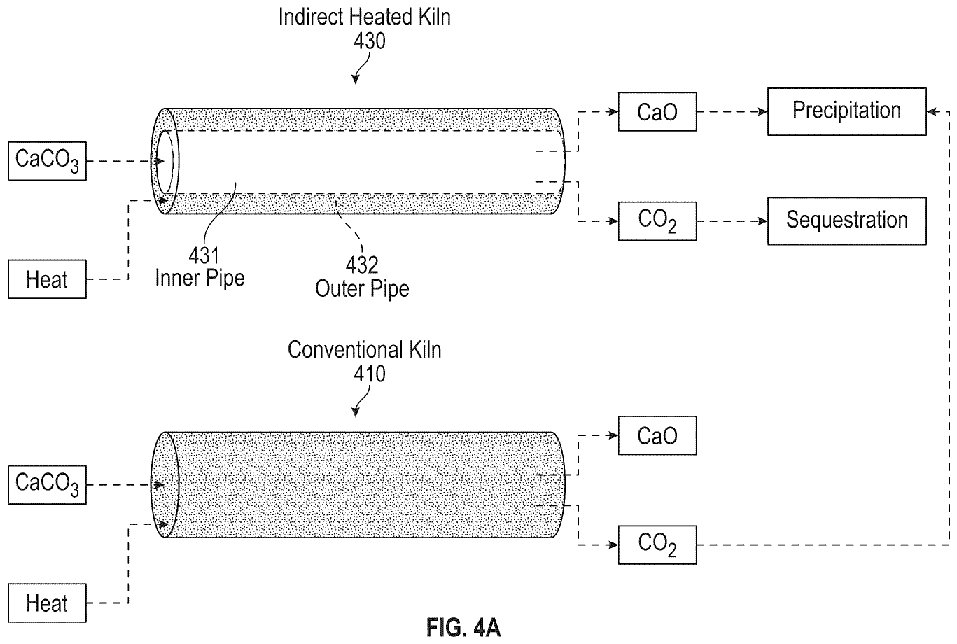

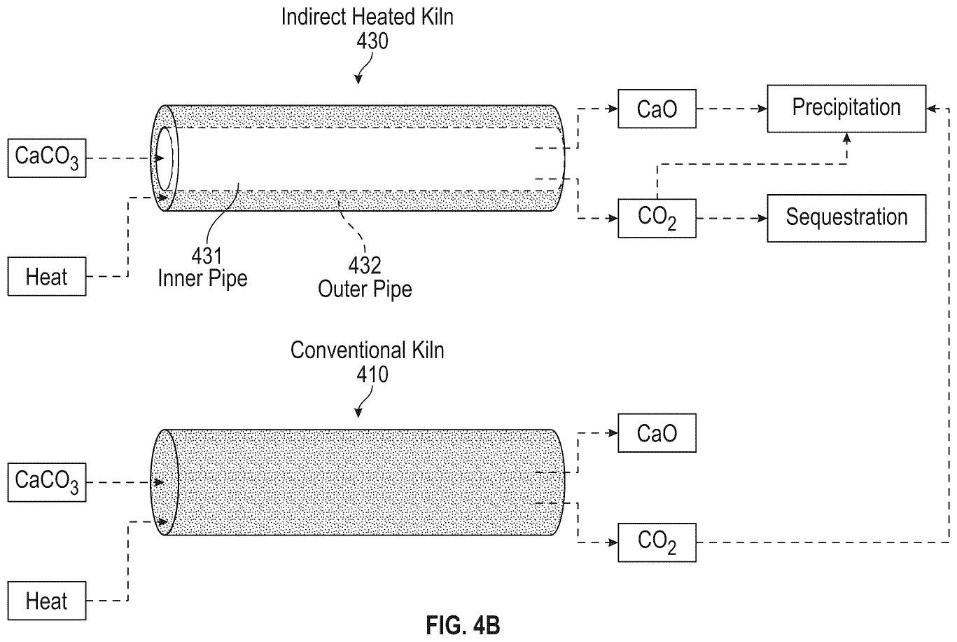

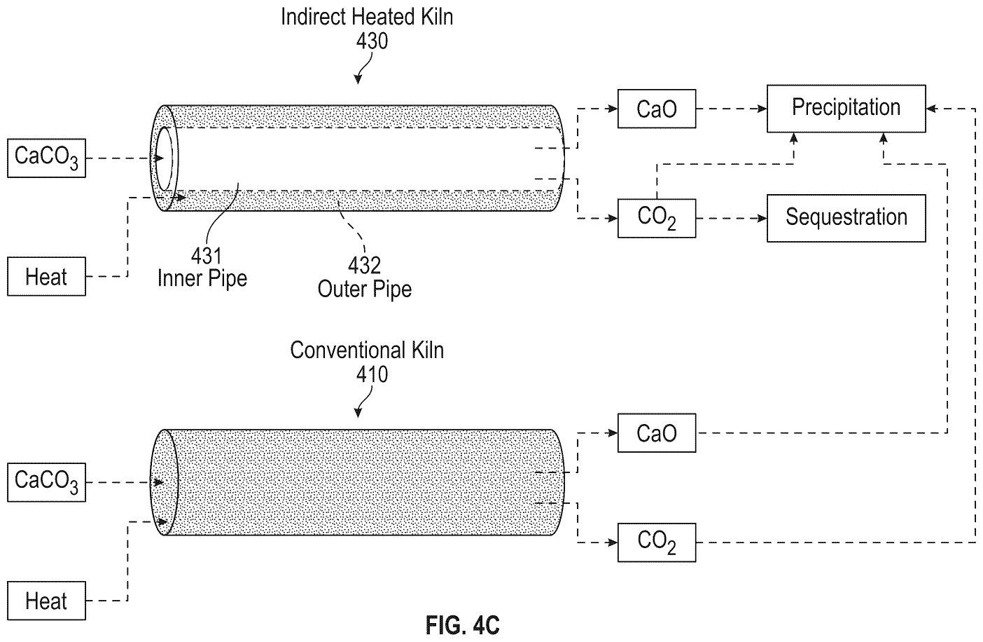

FIG. 4A is an illustration of the sequestration and precipitation processes according to various aspects. Conventional kiln 410 may be an existing kiln in a cement factory. As seen in the figure, the heat and the limestone are input to conventional kiln 410 through the same compartment.

Indirect heated kiln, however, takes limestone and the heat through different compartments. The limestone is input to inner pipe 431 while the heat is input to outer pipe 432.

The precipitation process uses the lime output from inner pipe 431 of indirect heated kiln 430 along with carbon dioxide from conventional kiln 410 which does not need to be a highly pure stream of carbon dioxide.

The carbon dioxide generated in inner pipe 431, however, is of high purity and is suitable for sequestration.

FIG. 4B is an illustration of the system that uses high purity CO₂ for both sequestration and precipitation according to various aspects. In these aspects, a portion of the purer carbon dioxide exiting inner pipe 431 of indirect heated kiln 430, is used for production of cementitious precipitated calcium carbonate. Another portion of this purer carbon dioxide may be used for sequestration however as seen in the figure. The system may also use a portion of the less pure carbon dioxide produced in conventional kiln 410 for precipitation.

FIG. 4C is an illustration of the system that uses different sources CO₂ and calcined lime for precipitation. In these aspects, a portion of the purer carbon dioxide exiting inner pipe 431 of indirect heated kiln 430 and a portion of the calcined lime from conventional kiln 410, may be used for production of cementitious precipitated calcium carbonate. Another portion of this purer carbon dioxide may be used for sequestration however as seen in the figure. The system may also use a portion of the less pure carbon dioxide produced in conventional kiln 410 for precipitation.

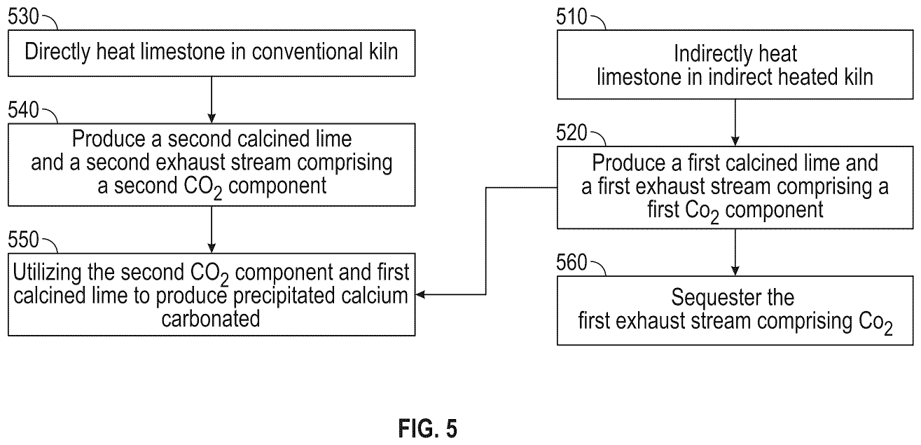

FIG. 5 is an illustration of a flowchart of an example method for cement production according to various aspects. Various steps in the flowchart may be performed with alternative sequences or sometimes simultaneously.

At step 510, an indirect heating kiln is used for indirectly heating and calcining or pre-calcining limestone. The indirect heating may be achieved by physically separating the volume where the limestone resides from the volume where the heating is provided. An example of this setup was provided above.

At step 520, as a result of the indirect heating of the limestone, there is produced a first calcined lime and a first exhaust stream containing a first CO₂ component which is a purer stream of carbon dioxide. The purity of the first carbon dioxide component in this first steam may exceed 80% or even 90% by weight of the whole stream.

At step 530, a conventional kiln is used to directly heat limestone. The conventional kiln is one in which the limestone and the heating process are not separated. For instance, a fossil fuel heating mechanism may be used in the same volume in which the limestone resides.

At step 540, as a result of the direct heating in the conventional kiln, there is produced a second calcined lime and a second exhaust stream comprising a second CO₂ component. The second carbon dioxide component is not nearly as pure as the first carbon dioxide component, and as such, is not suitable for geological sequestration for example. The purity of the second carbon dioxide component may be less than 50% or less than 30% by weight of the whole second stream.

At step 550, the second CO₂ component is utilized to produce precipitated calcium carbonated from the first calcined lime. The precipitation process is described above in this disclosure. The precipitated calcium carbonate may be in any of the polymorphs including vaterite, aragonite, or calcite.

At step 560, the first exhaust stream containing purer first CO₂ is prepared for sequestration. At this step, the stream may be compressed first before sequestration. In particular, because of the high purity of the carbon dioxide component, the steam may be geologically sequestered.

### Exemplary Aspects.

The following exemplary aspects are provided, the numbering of which is not to be construed as designating levels of importance:

Aspect 1 provides a cement production system comprising:
an Indirect heated kiln configured to produce a first calcined lime and a first exhaust stream comprising a first CO₂ component;
a direct heated kiln configured to produce a second calcined lime and a second exhaust stream comprising a second CO₂ component; and,
a precipitation reactor configured to utilize the second CO₂ component to produce precipitated calcium carbonate from the first calcined lime.

Aspect 2 provides the cement production system of Aspect 1, further comprising a sequestration module configured to sequester the first exhaust stream comprising CO₂.

Aspect 3 provides the cement production system of Aspect 2, wherein the sequestration module is configured to geologically sequester the first exhaust stream comprising CO₂.

Aspect 4 provides the cement production system of Aspect 1, wherein at least one of the direct heated kiln and the indirect heated kiln operates at least partially on a fossil fuel alternative heating mechanism.

Aspect 5 provides the cement production system of Aspect 4, wherein the fossil fuel alternative heating mechanism comprises at least one of electric heating, solar heating, and geothermal heating.

Aspect 6 provides the cement production system of Aspect 1, wherein the first exhaust stream comprises at least 80% pure CO₂.

Aspect 7 provides the cement production system of Aspect 1, wherein the first exhaust stream comprises at least 90% pure CO₂.

Aspect 8 provides the cement production system of Aspect 1, wherein the second exhaust stream comprises CO₂ that is less than 50% pure.

Aspect 9 provides the cement production system of Aspect 1, wherein the second exhaust stream comprises CO₂ that is less than 30% pure.

Aspect 10 provides the cement production system of Aspects 1-9, wherein the precipitated calcium carbonate comprises at least one of vaterite, aragonite, and calcite.

Aspect 11 provides a method for cement production, the method comprising:
Indirectly heating limestone to produce a first calcined lime and a first exhaust stream comprising a first CO₂ component;
directly heating limestone to produce a second calcined lime and a second exhaust stream comprising a second CO₂ component; and,
utilizing the second CO₂ component to produce precipitated calcium carbonated from the first calcined lime.

Aspect 12 provides the method of Aspect 11, further sequestering the first exhaust stream comprising CO₂.

Aspect 13 provides the method of Aspect 12, wherein the sequestering comprises geologic sequestration.

Aspect 14 provides the method of Aspect 11, further using a fossil fuel alternative heating mechanism for at least one of direct heating and indirect heating.

Aspect 15 provides the method of Aspect 14, wherein the fossil fuel alternative heating mechanism comprises at least one of electric heating, solar heating, and geothermal heating.

Aspect 16 provides the method of Aspect 11, wherein the first exhaust stream comprises at least 80% pure CO₂.

Aspect 17 provides the method of Aspect 11, wherein the first exhaust stream comprises at least 90% pure CO₂.

Aspect 18 provides the method of Aspect 11, wherein the second exhaust stream comprises CO₂ that is less than 50% pure.

Aspect 19 provides the method of Aspect 11, wherein the second exhaust stream comprises CO₂ that is less than 30% pure.

Aspect 20 provides the method of Aspects 11-19, wherein the precipitated calcium carbonate comprises at least one of vaterite, aragonite, and calcite.

Aspect 21 provides a system for production of low carbon emission cement, the system comprising:
a conventional kiln;
a precipitation reactor in material communications with the conventional kiln;
an indirect heated kiln in material communications with the precipitation reactor; and,
a sequestration module in materials communications with the indirect heated kiln;

Aspect 22 provides the system of Aspect 21, further comprising a compressor in material communications with the indirect heated kiln and the sequestration module.

Aspect 23 provides the system of Aspect 21, further comprising a production module in material communications with the precipitation reactor, and configured to produce materialized carbon dioxide.

Aspect 24 provides a system for production of low carbon emission cement, the system comprising:
an indirect heated kiln having a first volume and a second volume, the indirect kiln configured to input limestone into the first volume and input heat into the second volume and to produce lime and a first stream of carbon dioxide in the first volume and a second stream of carbon dioxide in the second volume;
a precipitation reactor configured to input the lime and the second stream of carbon dioxide and produce precipitated calcium carbonate cement; and
a sequestration module configured to input the first stream of carbon dioxide for sequestration.

Aspect 25 provides the system of Aspect 24, wherein the first stream of carbon dioxide is at least 80% pure.

Aspect 26 provides the system of Aspect 24, wherein the precipitation reactor inputs a portion of the first carbon dioxide.

Aspect 27 provides the system of Aspect 24, wherein the indirect heated kiln is configured to input a portion of a third carbon dioxide stream from a conventional kiln.

Aspect 28 provides the system of Aspect 24, wherein the indirect heated kiln is configured to operate as a pre-calciner.

Aspect 29 provides the system of Aspect 24, wherein the sequestration module is configured to prepare the first stream of carbon dioxide for geological sequestration.

Although the foregoing aspects have been described in some detail by way of illustration and example for purposes of clarity of understanding, it should be readily apparent to those of ordinary skill in the art in light of the present teachings, that certain changes and modifications may be made thereto without departing from the spirit or scope of the appended claims.

Accordingly, the preceding are illustrations of the principles of various aspects.

It will be appreciated that those skilled in the art may be able to devise various arrangements, which, although not explicitly described or shown in this disclosure, would still embody the principles of the aspects of this disclosure, and are included within its spirit and scope.

Furthermore, all examples and conditional language recited in this disclosure are principally intended to aid a person of ordinary skill in the art in understanding the principles of the aspects and the concepts contributed by the inventors to furthering the art, and are to be construed as being without limitation to such specifically recited examples and conditions.

Moreover, all statements of this disclosure, reciting principles, aspects, and aspects as well as specific examples, are intended to encompass both structural and functional equivalents of the aspects provided in the disclosure.

Additionally, it is intended that such equivalents include both currently known equivalents and equivalents developed in the future, i.e., any elements developed that perform an equivalent function, regardless of structure.

The scope of the aspects of this disclosure, therefore, is not intended to be limited to the examples illustrated and described in the disclosure.

Different components and functions of the aspects of this disclosure may be illustrated in different figures and assigned different reference numerals to correspond to the numbering scheme in a particular figure.

It is intended that the following claims define the scope of the aspects and that methods and structures within the scope of these claims and their equivalents be covered thereby.

1. A cement production system comprising:
an Indirect heated kiln configured to produce a first calcined lime and a first exhaust stream comprising a first CO₂ component;
a direct heated kiln configured to produce a second calcined lime and a second exhaust stream comprising a second CO₂ component; and,
a precipitation reactor configured to utilize the second CO₂ component to produce precipitated calcium carbonate from the first calcined lime.

2. The cement production system of claim 1, further comprising a sequestration module configured to sequester the first exhaust stream comprising CO₂.

3. The cement production system of claim 2, wherein the sequestration module is configured to geologically sequester the first exhaust stream comprising CO₂.

4. The cement production system of claim 1, wherein at least one of the direct heated kiln and the indirect heated kiln operates at least partially on a fossil fuel alternative heating mechanism.

5. The cement production system of claim 4, wherein the fossil fuel alternative heating mechanism comprises at least one of electric heating, solar heating, and geothermal heating.

6. The cement production system of claim 1, wherein the first exhaust stream comprises at least 80% pure CO₂.

7. The cement production system of claim 1, wherein the first exhaust stream comprises at least 90% pure CO₂.

8. The cement production system of claim 1, wherein the second exhaust stream comprises CO₂ that is less than 50% pure.

9. The cement production system of claim 1, wherein the second exhaust stream comprises CO₂ that is less than 30% pure.

10. The cement production system of claim 1, wherein the precipitated calcium carbonate comprises at least one of vaterite, aragonite, and calcite.

11. A method for cement production, the method comprising:
Indirectly heating limestone to produce a first calcined lime and a first exhaust stream comprising a first CO₂ component;
directly heating limestone to produce a second calcined lime and a second exhaust stream comprising a second CO₂ component; and,
utilizing the second CO₂ component to produce precipitated calcium carbonated from the first calcined lime.

12. The method of claim 11, further sequestering the first exhaust stream comprising CO₂.

13. The method of claim 12, wherein the sequestering comprises geologic sequestration.

14. The method of claim 11, further using a fossil fuel alternative heating mechanism for at least one of direct heating and indirect heating.

15. The method of claim 14, wherein the fossil fuel alternative heating mechanism comprises at least one of electric heating, solar heating, and geothermal heating.

16. The method of claim 11, wherein the first exhaust stream comprises at least 80% pure CO₂.

17. The method of claim 11, wherein the first exhaust stream comprises at least 90% pure CO₂.

18. The method of claim 11, wherein the second exhaust stream comprises CO₂ that is less than 50% pure.

19. The method of claim 11, wherein the second exhaust stream comprises CO₂ that is less than 30% pure.

20. The method of claim 11, wherein the precipitated calcium carbonate comprises at least one of vaterite, aragonite, and calcite.
